(19) United States
(12) Patent Application Publication
(10) Pub. No.: US 2019/0352939 A1
(43) Pub. Date: Nov. 21, 2019

(54) LOCKING PORTABLE LUNCH BOX WITH INNER REMOVABLE FOOD CONTAINER

(71) Applicant: Sonya Moore, Palmdale, CA (US)

(72) Inventor: Sonya Moore, Palmdale, CA (US)

(21) Appl. No.: 16/409,864

(22) Filed: May 12, 2019

Related U.S. Application Data
(60) Provisional application No. 62/672,016, filed on May 15, 2018.

(51) Int. Cl. E05B 65/52; A45C 11/20; B65D 55/14

(52) U.S. Cl. CPC E05B 65/5269; B65D 2255/00; B65D 55/14; A45C 11/20

(57) ABSTRACT

A Locking Portable Lunch Box with Inner Removable Food Container comprising a locking outer compartment structured and arranged to provide consumers with a means of keeping their food items from being eaten by others when using a shared refrigerator.

### CROSS-REFERENCE TO RELATED APPLICATION

The present application is related to and claims priority from prior provisional application Ser. No. 62/672,016, filed May 15, 2018 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. Field of the Invention

The present invention relates generally to the field of lunch boxes and more specifically relates to a locking portable lunch box with inner removable food container comprising a locking outer compartment structured and arranged to provide consumers with a means of keeping their food items from being eaten by others when using a shared refrigerator.

### 2. Description of the Related Art

From an early age, everyone is taught the concept of sharing. Defined as participating in, using, enjoying, or experiencing jointly or in turns, sharing is a major part of everyday existence. Drivers have to share the road; families and friends have to share living spaces. Ingrained in most people, the concept of sharing is relatively easy to follow, as long as the boundaries of give and take are adhered to respectfully. However, the boundaries of sharing are crossed from time to time, leading to confrontations and arguments. The little sister who “borrows” her older sibling's blouse without asking could be in for trouble when found out; a father would certainly not be pleased to learn his teenage son has taken the family car for a spin without asking permission. Even food stored in a shared refrigerator can quite often sow the seeds of bitterness. Unfortunately, this household appliance is considered by many to be a free-for-all; anything stored within is for the taking, regardless to whom it belongs.

A mother may be understandably upset to find that her children have consumed the entire platter of sandwiches she had prepared for arriving guests. A college student would have a right to fume when discovering, upon opening the refrigerator, that his roommate has scarfed every chocolate chip cookie his grandmother sent him Even the common refrigerator located in the office kitchen is not safe from coworker pilferage. Imagine a secretary's chagrin when finding that the delicious leftovers she was planning to enjoy for lunch have already been inhaled by some mysterious refrigerator bandit, leaving nothing but the empty dish on the cooling shelf. As many would readily attest, leaving personal food items in a shared refrigerator is risky business.

Various attempts have been made to solve problems found in lunch boxes art. Among these are found in: U.S. Pub. No. 2015/0335119 to Dion Baker; U.S. Pat. No. D364320 to Edward E. Sipe; U.S. Pat. No. 8,550,290 to Robert L. Davis; and U.S. Pat. No. 5,427,265 to Cautereels et al. This prior art is representative of lunch boxes comprising locking means.

Ideally, a locking portable lunch box with inner removable food container should be user-friendly and safe in-use and yet would operate reliably and be manufactured at a modest expense. Thus, a need exists for a locking portable lunch box with inner removable food container comprising a locking outer compartment structured and arranged to provide consumers with a means of keeping their food items from being eaten by others when using a shared refrigerator and to avoid the above-mentioned problems.

### BRIEF SUMMARY OF THE INVENTION

In view of the foregoing disadvantages inherent in the known lunch boxes art, the present invention provides a novel Locking Portable Lunch Box with Inner Removable Food Container. The general purpose of the present invention, which will be described subsequently in greater detail is to provide a locking portable lunch box with inner removable food container comprising a locking outer compartment structured and arranged to provide consumers with a means of keeping their food items from being eaten by others when using a shared refrigerator.

A lunch box comprising: an outer shell and removable inner food container unit. The outer shell comprises a shell body, a hinge-mounted lid, a rubberized seal arranged to fully seal the shell body with the hinge-mounted lid, and a locking mechanism, wherein the hinge-mounted lid can be secured closed to the shell body with the locking mechanism. Wherein the outer shell further comprises a material selected from the group consisting of a plastic material, a metal material, and a natural material. Wherein the locking mechanism is a lock that is secured with a key.

The removable inner food container unit further comprises a food container base, and a food container lid. Wherein the food container base is sealable with the food container lid. Wherein the food container base and the food container lid comprise material selected from the group consisting of a microwave and dishwasher-safe plastic material and a microwave and dishwasher-safe glass.

The present invention holds significant improvements and serves as a Locking Portable Lunch Box with Inner Removable Food Container. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, a Locking Portable Lunch Box with Inner Removable Food Container, constructed and operative according to the teachings of the present invention.

FIG. 1 shows a perspective view illustrating a lunch box of the Locking Portable Lunch Box with Inner Removable Food Container of the according to an embodiment of the present invention.

FIG. 2 is a perspective view illustrating the Locking Portable Lunch Box with Inner Removable Food Container in a locked condition of the according to an embodiment of the present invention of FIG. 1.

FIG. 3 is a perspective view illustrating another view of the lunch box of the Locking Portable Lunch Box with Inner Removable Food Container according to an embodiment of the present invention of FIG. 1.

The various embodiments of the present invention will hereinafter be described in conjunction with the appended drawings, wherein like designations denote like elements.

### DETAILED DESCRIPTION

As discussed above, embodiments of the present invention relate to a lunch box and more particularly to a Locking Portable Lunch Box with Inner Removable Food Container comprising a locking outer compartment structured and arranged to provide consumers with a means of keeping their food items from being eaten by others when using a shared refrigerator.

Generally speaking, the Locking Portable Lunch Box with Inner Removable Food Container comprising a novel product offering consumers a practical solution to the aforementioned challenges. As the name implies, the Locking Portable Lunch Box with Inner Removable Food Container comprises a specially designed a line of microwave safe food containers insert into an outer shell that can be secured closed with a lock. The outer shell is fabricated of a durable, high-impact plastic, metal, or natural material. The Locking Portable Lunch Box with Inner Removable Food Container would be square and/or rectangle in shape, offered in individual lunch-box size and platter-size configurations. The units would measure between four to eighteen inches in length, four to eighteen inches in width, and two to ten inches in depth.

A hinge-mounted lid would be provided with a rubberized seal to ensure a fully sealed enclosure. Located on the front of the lid would be the containers locking mechanism, which would be unlocked with keys (2) provided with the product. Constructed of a plastic material or glass, the removable microwave safe food container would be secured and locked inside saving food from uninvited tampering, this versatile product line would also keep foods fresh and tasty while stored in a refrigerator.

Dishwasher safe, the components could be easily cleaned after use. The Locking Portable Lunch Box with Inner Removable Food Container line could be offered in a wide variety of colors and materials to appeal to individual tastes. Made of durable, high quality materials, this product line should withstand years of continued use.

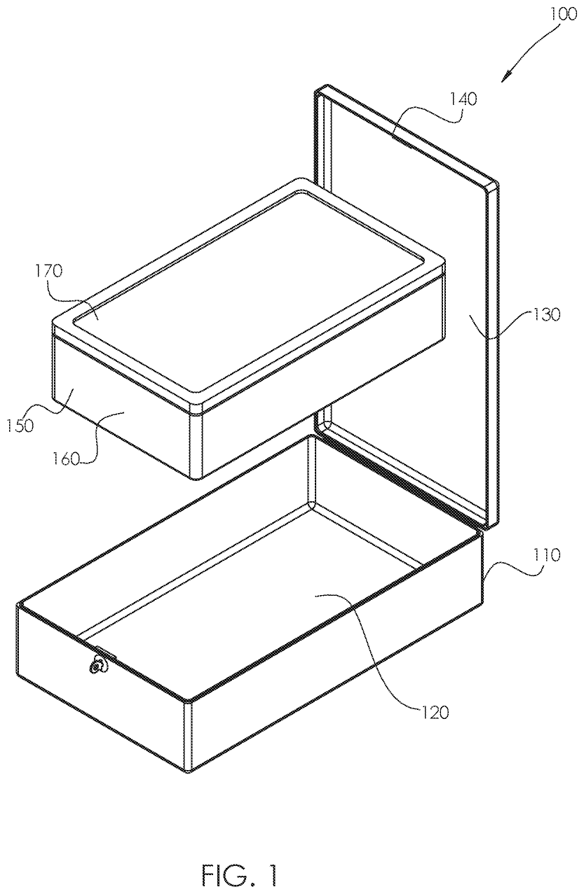

Referring to the drawings by numerals of reference there is shown in FIGS. 1-3 illustrating, perspective views illustrating locking portable lunch box 100 with inner removable food container 150 according to an embodiment of the present invention.

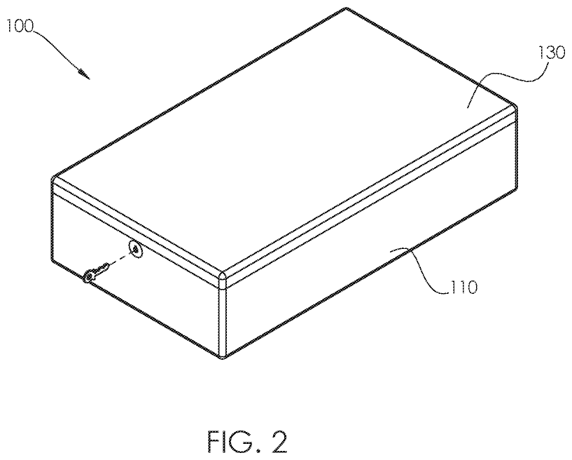

Lunch box 100 is disclosed herein in a preferred embodiment comprising: outer shell 110 and removable inner food container unit 150. Outer shell 110 comprises shell body 120, hinge-mounted lid 130, rubberized seal 140 arranged to fully seal shell body 120 with hinge-mounted lid 130 as shown in FIG. 2, and locking mechanism 200, wherein hinge-mounted lid 130 can be secured closed to shell body 120 with locking mechanism 200. Wherein locking mechanism 200 is a lock that is secured with key 210 as shown in FIG. 2. Wherein outer shell 110 further comprises a material selected from the group consisting of a plastic material, a metal material, and a natural material.

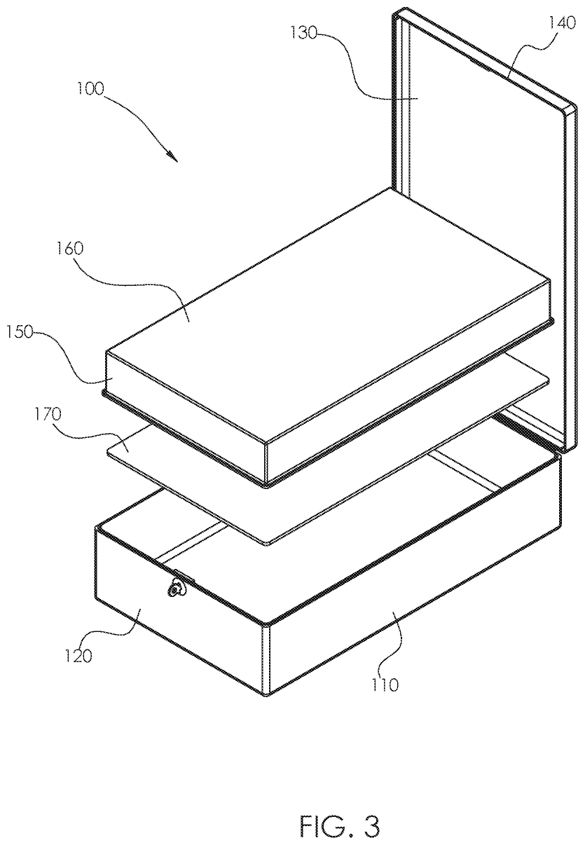

Removable inner food container unit 150 further comprises food container base 160, and food container lid 170 as shown in FIG. 3. Wherein inner food container base 160 is sealable with food container lid 170 as shown in FIG. 1. Wherein food container base 160 and food container lid 170 comprise material selected from the group consisting of a microwave and dishwasher-safe plastic material and a microwave and dishwasher-safe glass. Wherein inner food container unit 150 measures between four and eighteen inches in length, between four and eighteen inches in width, and between two and ten inches in depth.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claim:

1. A lunch box comprising:
a) an outer shell, further comprising
1) a shell body,
2) a hinge-mounted lid,
3) a rubberized seal arranged to fully seal the shell body with the hinge-mounted lid, and
4) a locking mechanism, wherein the hinge-mounted lid can be secured closed to the shell body with the locking mechanism; and
b) a removable inner food container unit, wherein the inner food container unit further comprises
1) a food container base, and
2) a food container lid,
wherein the food container base is sealable with the food container lid, and wherein the food container base and the food container lid comprise one or more microwave-safe materials.

2. The lunch box according to claim 1, wherein the inner food container unit measures between four and eighteen inches in length, between four and eighteen inches in width, and between two and ten inches in depth.

3. The lunch box according to claim 1, wherein the inner food container base and the inner food container lid further comprise one or more dishwasher-safe materials.

4. The lunch box according to claim 1, wherein the locking mechanism is a lock that is secured with a key.

5. The lunch box according to claim 1, wherein the outer shell further comprises a material selected from the group consisting of a plastic material, a metal material, and a natural material.

6. The lunch box according to claim 1, wherein the inner food container unit comprises material selected from the group consisting of a plastic material and glass.

7. The lunch box according to claim 6, wherein the inner food container base comprises a glass material and the inner food container lid comprises a plastic material.

8. The lunch box according to claim 6, wherein both the inner food container base and the inner food container lid comprise a plastic material.

9. A lunch box comprising:
a) an outer shell, further comprising
1) a shell body,
2) a hinge-mounted lid,
3) a rubberized seal arranged to fully seal the shell body with the hinge-mounted lid, and
4) a locking mechanism, wherein the hinge-mounted lid can be secured closed to the shell body with the locking mechanism,
wherein the outer shell further comprises a material selected from the group consisting of a plastic material, a metal material, and a natural material, and
wherein the locking mechanism is a lock that is secured with a key; and
b) a removable inner food container unit, wherein the inner food container unit further comprises
1) a food container base, and
2) a food container lid,
wherein the food container base is sealable with the food container lid,
wherein the food container base and the food container lid comprise material selected from the group consisting of a microwave and dishwasher-safe plastic material and a microwave and dishwasher-safe glass.

10. The lunch box according to claim 7, wherein the inner food container unit measures between four and eighteen inches in length, between four and eighteen inches in width, and between two and ten inches in depth.
